(19) United States
(12) Patent Application Publication
(10) Pub. No.: US 2014/0361991 A1
(43) Pub. Date: Dec. 11, 2014

(54) METHOD AND ELECTRONIC DEVICE FOR CONTROLLING MOUSE MODULE

(71) Applicant: Hisense Hiview Tech Co. Ltd, Shandong (CN)

(72) Inventors: Weilei Yang, Shandong (CN); Tongqing Gao, Shandong (CN); Liang Ma, Shandong (CN)

(21) Appl. No.: 13/979,376

(22) PCT Filed: Apr. 28, 2012
(86) PCT No.: PCT/CN2012/074916

§ 371 Date: Jul. 12, 2013

(30) Foreign Application Priority Data
Feb. 24, 2012 (CN) 201210046342.8

(51) Int. Cl. G06F 3/0354

(52) U.S. Cl. CPC G06F 3/03543
USPC 345/163

(57) ABSTRACT

The invention discloses a method and electronic device for controlling a mouse module, the method being applied to an electronic device loaded with an operating system, wherein the electronic device includes at least one first type of program function module and at least one second type of program function module, the first type of program function module is a module capable of background operation in the operating system in a preset period of time, and the second type of program function module is a module capable of responding to an operation only when an application interface is displayed; and the mouse module includes a mouse service module and a mouse function module corresponding to the mouse service module, and the mouse service module belongs to said at least one first type of program function module; and the method includes: obtaining a mouse function control instruction from a first application module, wherein the first application module belongs to said at least one second type of program function module; and controlling the mouse module based upon the mouse function control instruction to enable the mouse function module in a started or stopped status.

This application claims the benefit of Chinese Patent Application No. 201210046342.8, filed with the Chinese Patent Office on Feb. 24, 2012 and entitled “Method and electronic device (or controlling mouse module”, which is hereby incorporated by reference in its entirety.

### FIELD

The present invention relates to the field of computer technologies and particularly to a method and electronic device for controlling a mouse module.

### BACKGROUND

Existing electronic devices, e.g., a television set, etc., are generally controlled by a remote controller, but for electronic devices with a touch screen, e.g., a mobile phone with a touch screen, a television set with a touch screen, etc., the touch screen of the mobile phone can be operated, e.g., clicked, long-pressed, slide, etc., with a finger. However for the television set with a touch screen, an operating user tends to be at some distance from the television set, and the use of the touch approach is obviously very inconvenient and fails to offer a good user experience.

In order to address the foregoing technical problem, the television set is controlled with a mouse, and as commonly practiced at present, a wired or wireless mouse is connected externally, an air mouse function on a remote controller is started, a gesture control mouse is used with a 2D or 3D camera, etc. A mouse is traditionally added by writing a mouse function into codes of a television set system, that is, mouse codes are written respectively into module codes of respective scenarios, so an underlying driver is required for processing. For example, the underlying driver processes a mouse event into a standard Linux mouse event and forwards it to an upper-layer system to perform corresponding control. Alternatively, for example, at an underlying layer of the system, an obtained key pressing operation is translated into coordinate information, and then a mouse is drawn by coordinate points, and a data structure and an event are self-defined to determine a mouse operation corresponding to the key pressing action. Thus codes of any module involving the mouse have to be added, and no mouse operation can be performed for a module which is not added. For example, in order to start a mouse on a home page, mouse codes have to be added into codes of the home page, and no mouse operation can be performed on other pages for which codes have no source code of the mouse added thereto.

The inventors have identified during making of the invention at least the following problems:

Firstly, participation or handling of the underlying layer of the system is generally required in the prior art, thus resulting in complexity and a prolonged cycle of development and a poor user experience.

Secondly, mouse codes have to be written into respective scenarios or applications in the prior art, so no mouse operation can be performed for an application without any mouse code added thereto.

### SUMMARY

The invention provides a method and electronic device for controlling a mouse module so as to address the problems of a mouse operation solution in the prior art of involving an underlying layer of a system and of failing to perform a mouse operation for an application without any mouse code added thereto.

An aspect of the invention provides a method of controlling a mouse module, the method being applied to an electronic device loaded with an operating system, wherein the electronic device includes at least one first type of program function module and at least one second type of program function module, the mouse module includes a mouse service module and a mouse function module corresponding to the mouse service module, and the mouse service module belongs to said at least one first type of program function module; the first type of program function module is a module capable of background operation in the operating system in a preset period of time, and the second type of program function module is a module capable of responding to an operation only when an application interface is displayed, and the method includes: obtaining a mouse function control instruction from a first application module, wherein the first application module belongs to said at least one second type of program function module; and controlling the mouse module based upon the mouse function control instruction to enable the mouse function module in a started or stopped status.

Another aspect of the invention provides an electronic device loaded with an operating system, wherein the electronic device includes at least one first type of program function module and at least one second type of program function module, the first type of program function module is a module capable of background operation in the operating system in a preset period of time, and the second type of program function module is a module capable of responding to an operation only when an application interface is displayed, and the electronic device further includes: a mouse module including a mouse service module and a mouse function module corresponding to the mouse service module, wherein the mouse service module belongs to said at least one first type of program function module; an obtaining module configured to obtain a mouse function control instruction from a first application module, wherein the first application module belongs to said at least one second type of program function module; and a controlling module configured to control the mouse module based upon the mouse function control instruction to enable the mouse function module in a started or stopped status.

Still another aspect of the invention provides an electronic device loaded with an operating system, wherein the electronic device includes: a mouse module including a mouse service module and a mouse function module corresponding to the mouse service module, wherein the mouse module is located at the system layer of the operating system and capable of background operation in the operating system in a preset period of time; and mouse action recognizing means, installed on the electronic device, configured to recognize a mouse action when the mouse function module is in a started status, wherein the mouse service module sends a corresponding mouse event message to the operating system according to the mouse action.

Advantageous effects of the invention are as follows:

In an embodiment of the invention, a mouse module is built into a mouse service, and a mouse function is written into the mouse service, and when an application needs to access the mouse function or does not need the mouse function, the application simply sends a mouse function control instruction, and the mouse module is controlled based upon the mouse function control instruction to enable a mouse function module in a started or stopped status, so the method according to this embodiment can be performed simply at the application layer of the system without involving an underlying layer of the system. Furthermore the mouse function can be accessed without writing codes of the mouse function into respective applications, thus resulting in a simple implementation and a good user experience.

Furthermore in an embodiment of the invention, a mouse action is captured when the mouse function is started, and then the mouse action is converted into a system standard event message to emulate a mouse operation, that is, an original system standard event of an operating system is utilized without self-defining a data structure and an event or memorizing a gesture or a pressed key, and a user can operate totally in a mouse operation mode familiar to the user himself or herself without learning it again and a consequential memory burden, thus resulting in much more simple and convenient use.

Still furthermore in an embodiment of the invention, a display layer is added on a screen of a display unit, and the mouse is displayed on the display layer to emulate, for example, a mouse available on a computer so as to operate the electronic device intuitively, visually and more conveniently.

### BRIEF DESCRIPTION OF THE DRAWINGS

FIG. 1 is a flow chart of a method of controlling a mouse module according to an embodiment of the invention;

FIG. 2 is a flow chart of starting or stopping a mouse function module according to a first embodiment of the invention;

FIG. 3 is a flow chart of starting or stopping a mouse function module according to a second embodiment of the invention;

FIG. 4 is a flow chart of starting or stopping a mouse function module according to a third embodiment of the invention; and

FIG. 5 is a functional block diagram of an electronic device according to an embodiment of the invention.

### DETAILED DESCRIPTION OF THE EMBODIMENTS

A first embodiment of the invention provides a method of controlling a mouse module, and this method is applied to an electronic device, e.g., a television set, a mobile phone, a tablet computer, etc. The electronic device is loaded with an operating system, e.g., an Android system, a Symbian system, etc., and the electronic device includes at least one first type of program function module and at least one second type of program function module, where the mouse module includes a mouse service module and a mouse function module corresponding to the mouse service module, and the mouse module belongs to said at least one first type of program function module; and the first type of program function module is a module capable of background operation in the operating system in a preset period of time, is typically located at the system layer of the operating system and has no visual user interface, e.g., a service, and the second type of program function module is a module capable of responding to an operation only when an application interface is displayed, is typically located at the application layer of the operating system and has a user interface, e.g., such an application as a browser. Referring to FIG. 1, FIG. 1 is a flow chart of the method of controlling a mouse module according to this embodiment.

As illustrated in FIG. 1, the method includes:

The step 101 is to obtain a mouse function control instruction from a first application module, where the first application module belongs to said at least one second type of program function module.

The step 102 is to control the mouse module based upon the mouse function control instruction to enable the mouse function module in a started or stopped status.

In order to describe the invention in further details, the invention will be described below in particular instances, where the electronic device is a television set and the operation system is an Android system, for example.

Firstly a service is built into a mouse service module, and then codes to perform a mouse function are written into the mouse service module to form a mouse function module. Since the service is capable of background operation for a defined period of time, the mouse function can be validated. And a method of starting or stopping the mouse function in this embodiment can be performed simply at the application layer of the system without involving an underlying layer of the system. Furthermore the mouse function can be accessed without writing the codes of the mouse function into respective applications, thus resulting in a simple implementation and a good user experience.

When an application needs to access the mouse function, it can send a mouse function control instruction, and correspondingly in the step 101, the mouse function control instruction from the application can be obtained, and then the step 102 is performed to control the mouse module based upon the mouse function control instruction to enable the mouse function module in a started or stopped status.

Particularly in the step 101, the mouse function control instruction from the first application module can be obtained particularly by receiving an invoking instruction from the first application module to invoke the mouse function module, and this will be described below in two particular instances.

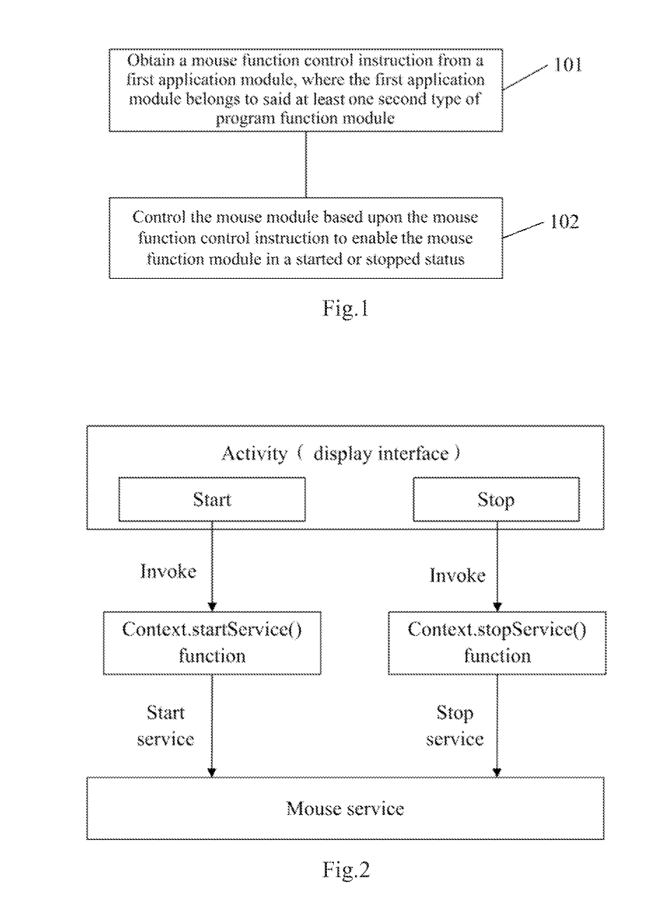

First the mouse service module is started by invoking Context.startService( ) or the mouse service module is stopped by invoking Context.stopService( ) in a self-defined Activity, and in this approach, each time the system is started, then a mouse application is entered, and the mouse service is started or stopped in the application with a button, a option box and other controls, where the Activity is a fundamental application component of the Android system. In an application, an Activity is a separate display interface for display and interaction with a user. Reference is made to FIG. 2 for a flow chart of this approach.

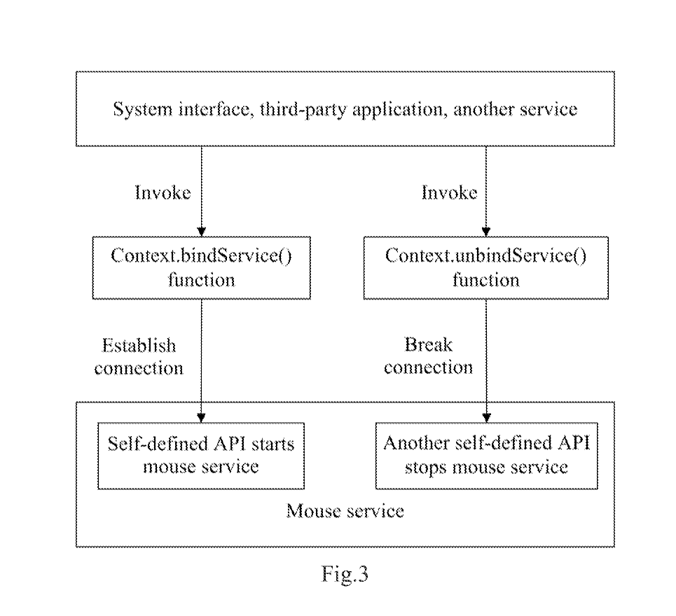

Second an invoking interface (an Application Programming Interface (API)) is self-defined in the mouse service module, and a system interface, an Activity of a third-party application or another service invokes the mouse service by establishing a connection to the mouse service module. A connection is established using the Context.bindService( ) function and closed using the Context.unbindService( ) function. Particularly an API function is defined in source codes of the mouse service module and made public to the outside in the form of a document, etc. When the system, the third-party application or the other service program is defined during development to be combined with a mouse function, corresponding codes are added in development source codes of the system, the third-party application or the other service program to establish or close a connection with the mouse service, and the previously defined API of the mouse service is invoked after the connection is established. This approach requires this API defined in the mouse service to be known to the system, the third-party application or the other service program during development, that is, the mouse API shall be defined before the other modules accessing the API. Reference is made to FIG. 3 for a flow chart of this approach.

In the first approach and the second approach, the mouse service module will not be opened and operated until being invoked by the API function, and the mouse service module may not be started and stopped separately from but together with the mouse function module, that is, the mouse function is active immediately after the mouse service module is started; and the mouse function is inactive immediately after the mouse service module is stopped.

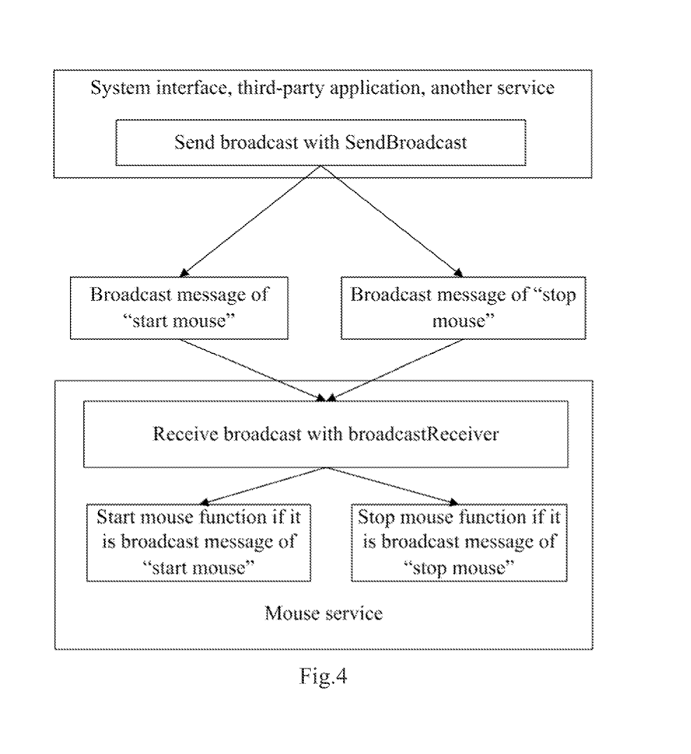

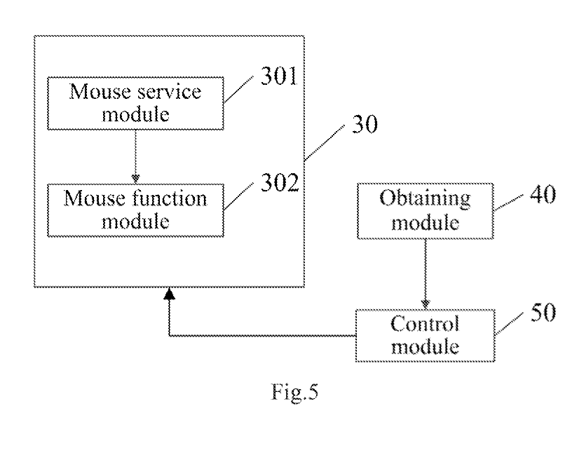

In another embodiment, the step 101 can particularly receive a broadest message from the first application module to control the mouse function module, that is, a third approach in which the system interface, the Activity of the third-party application or the other service needing to access the mouse function sends a broadcast message (the broadcast message has been self-defined in the mouse service module as an API provided to the system interface, the Activity of the third-party application or the other service for use). A broadcast receiving module (broadcastReceiver) is also defined in the mouse service module to start the mouse function upon reception of a broadcast message of “Start Mouse” and to stop the mouse function upon reception of a broadcast message of “Stop Mouse”. Particularly in this approach, one or more characters are defined as a message to be broadcast. Then codes to receive a broadcast message are added and a corresponding operation to be performed upon reception of a specific broadcast message is defined in the mouse service module. For example, a segment of codes in the mouse service module will be responsible for starting the mouse function module upon reception of a broadcast message of “Start Mouse”, and there will also a segment of codes corresponding to “Stop Mouse” to stop the mouse function module. The system interface, the third-party application and the other service needing to access the mouse function can send a broadcast message of “Start Mouse” or “Stop Mouse” as needed. Reference is made to FIG. 4 for a flow chart of this approach.

In this approach, the mouse service module is in operation all the time, and the mouse function is started and stopped by a broadcast message. With this approach, the problem of confliction between 2D or 3D gesture recognition and the use of a camera by another third-party video application can be addressed. For example, a camera typically needs to be used as a recognizing device for a gesture recognizing mouse, and when the camera needs to be used for the third-party application, if the mouse function is started, then the third-party application can simply send a broadcast message to stop the mouse function and then send a broadcast message to start the mouse function upon exit from the third-party application.

Of the foregoing three approaches, the first approach is applicable to addition of the mouse function in the case that the system, the third-party application or the other service has been developed, and the second and third approaches are applicable to addition of the mouse function in the case that the system, the third-party application or the other service is under development.

In another embodiment, the step 102 can particularly check a flag, indicating whether the mouse function module is set to be started, based upon the mouse function control instruction; and controlling the mouse module to enable the mouse function module in a started status when the flag indicates the mouse function module to be started. Particularly the user can preset the mouse function to be started or not upon startup. When the user sets the mouse function to be started, a flag can also be set in a shared preference of /datedata/MousePackagename of the system; and when the user sets the mouse function to be stopped, the flag will be cleared under the path. When the television set system is started, the mouse service module (the mouse service module is another new mouse service module in the first approach or the second approach; and the mouse service module can be the same mouse service module in the third approach) starts operation and checks the flag under the path upon reception of a broadcast message of BOOT COMPETE. When the flag is set, then the mouse function module is started automatically; otherwise, the mouse function module is kept stopped. This embodiment can further improve a user experience.

How to perform a mouse operation when the mouse function module is in a started status will be introduced next.

Firstly for all of a gesture recognizing mouse, an air mouse and a general mouse, coordinate information of the mouse will be transported to the operating system via a standard interface of the operating system. The mouse service module then can obtain the coordinate information of the mouse from the operating system directly via the standard interface of the system. In the Android system, a mouse event (including coordinate values and an action) is transported to the standard system monitor function onTouchEvent( ) of the current application via the standard interface in the interface function injectPointerEvent( ) provided by the “Window Manager Service”, where for example, the coordinate information of the mouse is X/Y coordinate values adapted based upon the resolution of the current display unit.

Furthermore the mouse can be displayed on the display unit to emulate, for example, a mouse available on a computer so as to operate the electronic device intuitively, visually and more conveniently, particularly as follows: import android.view.MotionEvent, import android.view.IwindowManager and import android.view.ViewManager are added in the codes of the mouse service module; and these are standard classes of the Android system and belong to a part of the source codes of the Android system. A display layer is added on top of the screen of the display unit in the function addView( ) in ViewManager to draw the mouse (or to invoke a designed mouse picture), where the size of the display layer can be obtained with windowManager.getDefaultDisplay( ).getWidth( ) and windowManager.getDefaultDisplay( ).getHeight( ) and these functions are existing standard APIs to obtain the resolution of the current display of the display unit.

Next the user can operate the electronic device in an already familiar mouse operation mode, for example, with a gesture mouse, numerous operations can be performed with a grab action and a held grab action: single rapid grabbing is to click the left button of the mouse once, double rapid grabbing is to click the left button of the mouse twice, dragging after grabbing is to drag while pressing the left key of the mouse, long grabbing without any movement is to click the right button of the mouse once, and the mouse is moved by the user moving the hand upward, downward, leftward and rightward. A mouse event (including coordinate values and an action) is transported to the standard system monitor function onTouchEvent( ) of the current application in the interface function injectPointerEvent( ) provided by the “Window Manager Service”. Reference is made to Table 1 depicting mouse operations corresponding to separate events of touch screen operations in the Android system.

TABLE 1

| | Android touch | Emulated mouse |
|---|---|---|
| Event message | screen operation | operation |
| motionEvent.ACTION_DOWN | Press down on | Emulate action to |
| | screen | click downward |
| | | on mouse |
| motionEvent.ACTION_UP | Lift up on | Emulate action to |
| | screen | lift up after |
| | | clicking on mouse |
| motionEvent.ACTION_MOVE | Drag while | Emulate action to |
| | pressing on | drag while |
| | screen | pressing mouse key |

In this embodiment, when the standard system monitor function onTouchEvent( ) of the current application monitors a mouse action, the mouse service module sends a corresponding mouse event message to the operating system. Reference is made to Table 2 depicting mouse operations corresponding to combinations of events.

TABLE 2

| Emulated mouse operation | Sequentially sent event messages |
|---|---|
| Single click | motionEvent.ACTION_DOWN, |
| | motionEvent.ACTION_UP |
| Drag | motionEvent.ACTION_DOWN, |
| | motionEvent.ACTION_MOVE, |
| | motionEvent.ACTION_UP |
| Double click | motionEvent.ACTION_DOWN, |
| | motionEvent.ACTION_UP, |
| | motionEvent.ACTION_DOWN, |
| | motionEvent.ACTION_UP |

For example, when an action of the mouse is a singleclick action, at this time the event message motionEvent.ACTION_DOWN and the event message motionEvent.ACTION_UP are sent to the system, and since the single-click action is to firstly press down and then lift up, the event messages are sent to the system also in an order of firstly the event message motionEvent.ACTION_DOWN and then the event message motionEvent.ACTION_UP, and the system identifies the event messages upon reception of the event messages to thereby know what operation the mouse operation is. As such the single-click operation of the mouse can be performed. The same applies to dragging and double-click operations, and a repeated description thereof will be omitted here.

Moreover in the Android system, the system can receive operation information of the user only if the user contacts the touch screen, that is, the user presses down on the screen (that is, the event message motionEvent.ACTION_MOVE and the event message motionEvent.ACTION_UP can be identified respectively only after the event message motionEvent.ACTION_DOWN is sent). Thus in this embodiment, when a mouse operation is merely to move the mouse, equivalently there is not any press-down action performed (that is, it can be considered that the user slides on the touch screen instead of contacting the touch screen). Thus when the mouse is just moved, the mouse can simply be drawn by obtained coordinate values of the mouse on the display layer drawn in addView( ).

The foregoing embodiments have been described taking the Android system as an example, but in other embodiments, the operating system can alternatively be a Windows system, and the electronic device may not be provided with a touch screen operation, and a mouse function can be performed simply by converting a mouse operation into a standard system event message.

Another embodiment of the invention further provides an electronic device loaded with an operating system, for example, configured to perform the method of controlling a mouse module according to the foregoing embodiment. Reference is made to FIG. 5 illustrating a functional block diagram of the electronic device according to this embodiment.

As illustrated in FIG. 5, the electronic device includes: a mouse module 30 including a mouse service module 301 and a mouse function module 302 corresponding to the mouse service module 301, where the mouse service module 301 belongs to a first type of program function module; an obtaining module 40 configured to obtain a mouse function control instruction from a first application module, where the first application module belongs to a second type of program function module; and a control module 50 configured to control the mouse module 30 based upon the mouse function control instruction to enable the mouse function module 302 in a started or stopped status.

Particularly the obtaining module 40 is particularly configured to receive an invoking instruction from the first application module to invoke the mouse function module. Then the control module 50 is particularly configured to control the mouse service module 301 to be in a started or stopped status based upon the invoking instruction. For a particular instance thereof, reference can be made to the first approach and the second approach described above, and a detailed description thereof will be omitted here.

In another embodiment, the obtaining module 40 is particularly configured to receive a broadcast message from the first application module to control the mouse function module 302. Then the control module 50 is particularly configured to control the mouse function module 302 to be in a started or stopped status based upon the broadcast message. For a particular instance thereof, reference can be made to the third approach described above, and a detailed description thereof will be omitted here.

In another embodiment, the control module 50 particularly includes: a checking unit configured to check a flag, indicating whether the mouse function module 302 is set to be started, based upon the mouse function control instruction; and a controlling unit configured to control the mouse module 30 to enable the mouse function module 302 in a started status when the flag indicates the mouse function module 302 to be started and to control the mouse module 30 to enable the mouse function module 302 in a stopped status when the flag is not set.

In another embodiment, the electronic device further includes a display unit and an acquiring module, where the display unit is configured to display an operation object, and the acquiring module is configured to acquire coordinate information of a mouse on the display unit when the mouse function module 302 is in a started status, for example, in the Android system, a mouse event (including coordinate values and an action) is transported to the standard system monitor function onTouchEvent( ) of the current application in the interface function injectPointerEvent( ) provided by the “Window Manager Service”, where for example, the coordinate information of the mouse is X/Y coordinate values adapted based upon the resolution of the current display unit.

Furthermore a display layer is further provided on a screen of the display unit, and the electronic device further includes a display module configured to display the mouse on the display layer at a location corresponding to the coordinate information, for example, a display layer is added on top of the screen of the display unit in the function addView( ) in ViewManager to draw the mouse (or to invoke a designed mouse picture).

In another embodiment, the electronic device further includes a capturing module configured to capture a mouse action when the mouse function module 302 is in a started status, and the mouse service module 301 sends corresponding mouse event messages to the operating system according to the mouse action. Particularly the mouse service module 301 sends the corresponding mouse event messages in the same order as the mouse action takes place. For a particular instance, reference can be made to the operation process described in the method according to the foregoing embodiments, and a detailed description thereof will be omitted here.

The foregoing respective embodiments can be practiced separately or in combination, and those skilled in the art can choose as needed in practice.

Still another embodiment of the invention further provides an electronic device, e.g., a smart television set, a smart mobile phone, a tablet computer, etc., on which an operating system is loaded, and the electronic device includes: a mouse module including a mouse service module and a mouse function module corresponding to the mouse service module, where the mouse module is located at the system layer of the operating system and capable of background operation in the operating system in a preset period of time; and mouse action recognizing means, installed on the electronic device, configured to recognize a mouse action when the mouse function module is in a started status, where the mouse service module sends a corresponding mouse event message to the operating system according to the mouse action.

For example, the electronic device is a smart television set, the mouse module is as described in the foregoing embodiments, the operating system is, for example, the Android system, and the mouse action recognizing means is, for example, a 2D camera or 3D camera capable of recognizing a gesture mouse. Of course, the electronic device can further include other function modules, e.g., a loudspeaker, a control button, etc.

Furthermore the smart television set further includes a screen configured to display a picture, and a display layer on which the mouse can be displayed is further provided on the screen.

When the mouse action recognizing means, i.e., the camera, recognizes a gesture of a user to be single rapid grabbing, the mouse service module sends a mouse event message of clicking the left key once to the operating system, and the operating system processes the mouse event message and has the mouse displayed on the display layer click the left key of the mouse once; and the camera recognizes double rapid grabbing to be clicking the left key twice, dragging after grabbing to be dragging while pressing the left key of the mouse, and long grabbing without any movement to be clicking the right button of the mouse once, and the mouse is moved by the user moving the hand upward, downward, leftward and rightward.

The smart television set according to this embodiment operates relatively independently, and the user can operate the smart television set totally with a mouse (including a general mouse, an air mouse, a gesture recognition mouse, etc.) without dependence upon a remote controller.

Only the general structure and the mouse operation of the electronic device have been introduced in this embodiment, and for a particular implementation of the electronic device according to this embodiment, reference can be made to the embodiment of the method of controlling a mouse module described above, and a detailed description thereof will be omitted here.

In an embodiment of the invention, a mouse module is built into a mouse service, and a mouse function is written into the mouse service, and when an application needs to access the mouse function or does not need the mouse function, the application simply sends a mouse function control instruction, and the mouse module is controlled based upon the mouse function control instruction to enable a mouse function module in a started or stopped status, so the method according to this embodiment can be performed simply at the application layer of the system without involving an underlying layer of the system. Furthermore the mouse function can be accessed without writing codes of the mouse function into respective applications, thus resulting in a simple implementation and a good user experience.

Furthermore in an embodiment of the invention, a mouse action is captured when the mouse function is started, and then the mouse action is converted into a system standard event message to emulate a mouse operation, that is, an original system standard event of an operating system is utilized without self-defining a data structure and an event or memorizing a gesture or a pressed key, and a user can operate totally in a mouse operation mode familiar to the user himself or herself without learning it again and a consequential memory burden, thus resulting in much more simple and convenient use.

Still furthermore in an embodiment of the invention, a display layer is added on a screen of a display unit, and the mouse is displayed on the display layer to emulate, for example, a mouse available on a computer so as to operate the electronic device intuitively, visually and more conveniently.

Those skilled in the art shall appreciate that the embodiments of the invention can be embodied as a method, a system or a computer program product. Therefore the invention can be embodied in the form of an all-hardware embodiment, an all-software embodiment or an embodiment of software and hardware in combination. Furthermore the invention can be embodied in the form of a computer program product embodied in one or more computer useable storage mediums (including but not limited to a disk memory, a CD-ROM, an optical memory, etc.) in which computer useable program codes are contained.

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram,

Although the preferred embodiments of the invention have been described, those skilled in the art benefiting from the underlying inventive concept can make additional modifications and variations to these embodiments. Therefore the appended claims are intended to be construed as encompassing the preferred embodiments and all the modifications and variations coming into the scope of the invention,

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. A method of controlling a mouse module, the method being applied to an electronic device loaded with an operating system, wherein the electronic device comprises at least one first type of program function module and at least one second type of program function module, the first type of program function module is a module capable of background operation in the operating system in a preset period of time, and the second type of program function module is a module capable of responding to an operation only when an application interface is displayed, and wherein the mouse module comprises a mouse service module and a mouse function module corresponding to the mouse service module, and the mouse service module belongs to said at least one first type of program function module, and the method comprises:
obtaining a mouse function control instruction from a first application module, wherein the first application module belongs to said at least one second type of program function module; and
controlling the mouse module based upon the mouse function control instruction to enable the mouse function module in a started or stopped status.

2. The method according to claim 1, wherein the obtaining a mouse function control instruction from a first application module comprises:
receiving an invoking instruction from the first application module to invoke the mouse function module.

3. The method according to claim 2, wherein the controlling the mouse module based upon the mouse function control instruction to enable the mouse function module in a started or stopped status comprises:
controlling the mouse service module to be in a started or stopped status based upon the invoking instruction.

4. The method according to claim 1, wherein the obtaining a mouse function control instruction from a first application module comprises:
receiving a broadcast message from the first application module to control the mouse function module.

5. The method according to claim 4, wherein the controlling the mouse module based upon the mouse function control instruction to enable the mouse function module in a started or stopped status comprises:
controlling the mouse function module to be in a started or stopped status based upon the broadcast message.

6. The method according to claim 1, wherein when the mouse function module is in a started status, the method further comprises:
capturing a mouse action; and
the mouse service module sending a corresponding mouse event message to the operating system according to the mouse action.

7. The method according to claim 6, wherein the mouse service module sending a corresponding mouse event message to the operating system according to the mouse action comprises: sending corresponding mouse event messages in a same order that mouse actions take place.

8. The method according to claim 1, wherein the electronic device comprises a display unit to obtain coordinate information of a mouse on the display unit when the mouse function module is in a started status.

9. The method according to claim 8, wherein a display layer is added on a screen of the display unit, and the mouse is displayed on the display layer at a location corresponding to the coordinate information.

10. An electronic device, loaded with an operating system, wherein the electronic device comprises at least one first type of program function module and at least one second type of program function module, the first type of program function module is a module capable of background operation in the operating system in a preset period of time, and the second type of program function module is a module capable of responding to an operation only when an application interface is displayed, and wherein the electronic device further comprises:
a mouse module comprising a mouse service module and a mouse function module corresponding to the mouse service module, wherein the mouse service module belongs to said at least one first type of program function module;
an obtaining module configured to obtain a mouse function control instruction from a first application module, wherein the first application module belongs to said at least one second type of program function module; and
a control module configured to control the mouse module based upon the mouse function control instruction to enable the mouse function module in a started or stopped status.

11. The electronic device according to claim 10, wherein the obtaining module is further configured to receive an invoking instruction from the first application module to invoke the mouse function module.

12. The electronic device according to claim 11, wherein the control module is further configured to control the mouse service module to be in a started or stopped status based upon the invoking instruction.

13. The electronic device according to claim 10, wherein the obtaining module is further configured to receive a broadcast message from the first application module to control the mouse function module.

14. The electronic device according to claim 13, wherein the control module is further configured to control the mouse function module to be in a started or stopped status based upon the broadcast message.

15. The electronic device according to claim 10, wherein the electronic device further comprises a capturing module configured to capture a mouse action when the mouse function module is in a started status, and the mouse service module is configured to send a corresponding mouse event message to the operating system according to the mouse action.

16. An electronic device, loaded with an operating system, wherein the electronic device comprises:
a mouse module comprising a mouse service module and a mouse function module corresponding to the mouse service module, wherein the mouse service module is located at a system layer of the operating system and capable of background operation in the operating system in a preset period of time; and
mouse action recognizing means, installed on the electronic device, configured to recognize a mouse action when the mouse function module is in a started status, wherein the mouse service module is configured to send a corresponding mouse event message to the operating system according to the mouse action.

17. The electronic device according to claim 16, wherein the electronic device further comprises a screen on which there is a display layer with a mouse displayed thereon.
